(19) United States
(12) Patent Application Publication
(10) Pub. No.: US 2025/0032860 A1
(43) Pub. Date: Jan. 30, 2025

(54) GOLF BALL COMPONENT HAVING MULTIPLE COLOR CONCENTRATE ADDITIVES

(71) Applicant: Acushnet Company, Fairhaven, MA (US)

(72) Inventors: Edward Costa, East Providence, RI (US); Manjari Kuntimaddi, Raynham, MA (US)

(73) Assignee: Acushnet Company, Fairhaven, MA (US)

(21) Appl. No.: 18/226,916

(22) Filed: Jul. 27, 2023

(51) Int. Cl. A63B 37/00; C08J 3/20; C08L 21/00

(52) U.S. Cl. CPC A63B 37/00691; A63B 37/00373; A63B 37/00495; C08J 3/201; C08L 21/00; A63B 37/0074; A63B 37/0075; A63B 37/0076; C08J 2321/00; C08J 2475/02; C08J 2475/04; C08L 2207/53

(57) ABSTRACT

A golf ball component and method of forming the same is disclosed herein. The golf ball component includes color concentrate additives having different colors and different material properties, such as melt flow indices or Mooney viscosities. The golf ball component features a unique pattern or visual appearance based on the inclusion of the dissimilar color concentrate additives.

### FIELD OF THE INVENTION

This disclosure generally relates to a golf ball, and is more particularly related to a golf ball having a uniquely colored pattern or design due to multiple color concentrate additives.

### BACKGROUND OF THE INVENTION

Golf balls having varying designs and visual features are well known. Various printing or spraying techniques are typically used to apply a predetermined and controlled design or visual feature to the outer surface of a golf ball. Color concentrate additives (also referred to herein as “color concentrates”) are also a known component of golf ball design and typically are utilized to provide a single primary color to a golf ball, such as white for a traditional golf ball.

It would be desirable to provide a technique for producing golf ball components that improves manufacturing efficiencies, and is also capable of providing unique visual features and characteristics.

### SUMMARY OF THE INVENTION

In some embodiments, the present disclosure provides an arrangement in which various colors can be used in golf ball formation designs and techniques. In one aspect, the present disclosure is directed to using at least two different color concentrate additives that have at least one different material property besides different appearances or colors. The color concentrate additives can have different melting temperatures or durability to shearing torque (such as measured by Mooney viscosity), such that during processing (i.e., curing, grinding, forming, mixing, casting, etc.) the color concentrate additives will be irregularly blended or mixed to produce a distinct pattern or design. The color concentrate additives can be irregularly blended or mixed such that a marble pattern is produced in a component or layer of the golf ball. The color concentrate additives can be included in any layer or component of a golf ball, including a cover, casing, intermediate layer, core, etc.

In one aspect, a method of forming a golf ball component is disclosed. The golf ball component can include any sub-component, sub-assembly, layer, or other portion of the golf ball. The method can comprise forming at least one of a core, an intermediate layer, or a cover from a composition including a base material, a first color concentrate additive having a first color, and a second color concentrate additive having a second color. In one aspect, the first color concentrate additive can have a first melt flow index and the second color concentrate additive can have a second melt flow index that is different than the first melt flow index. In another aspect, the first color concentrate additive can have a first Mooney viscosity and the second color concentrate additive can have a second Mooney viscosity that is different than the first Mooney viscosity. In one aspect, the first and second color concentrate additives can have different melt flow indices and different Mooney viscosities.

The method can include curing or otherwise setting or hardening the composition to form the core, the intermediate layer, or the cover. The formation or curing process can include any steps as one of ordinary skill of the art would understand, such as heating. The composition can be ground or mixed prior to curing or formation. The composition of the golf ball component has a visual appearance in which the first color and the second color are each separately visible in the core, the intermediate layer, or the cover. As used in this context, the term separately visible can mean that an observer of ordinary or average visual acuity can readily ascertain the two distinct colors.

In one example, the first color concentrate additive is white, and the second color concentrate additive is non-white, such that the first and second color concentrate additives are configured to form a marbled pattern in the composition.

In another example, the first color concentrate additive is a first non-white color, and the second color concentrate additive is a second non-white color, such that the first and second color concentrate additives are configured to form a marbled pattern in the composition.

The composition can be semi-immiscible. As used in this context, the term semi-immiscible means that the first and second color concentrate additives do not fully mix and therefore do not form a homogonous mixture with each other, although the first and second color concentrate additives are fully miscible with the base material. As a result, the first and second color concentrate additives can each be independently or separately visible in the composition. Shades or gradations of the colors of each of the first and second color concentrate additives can be visible in the composition in one aspect. In one aspect, the first and second color concentrate additives each have a separate color as defined by the CIELAB color space prior to forming the golf ball component. Upon being mixed with each other, the colors of the first and second color concentrate additives do not fully mix such that the resulting color the golf ball component can include the first color and second color, as well as a mixture of the two CIELAB color space values. The golf ball component can have a unique patterning, which can resemble a marble pattern. Specks, striations, streaks, dots, veins, or other visual patterns can manifest in the composition based on the different material properties of the first and second color concentrate additives.

In one aspect, the first color concentrate additive is configured to flow using the ASTM D1238 testing standard with a specific testing temperature and a specific testing mass, and the second color concentrate additive does not flow using the ASTM D1238 testing standard with the specific testing temperature and the specific testing mass. Other melt flow index tests could be used, such as ISO 1133. In one aspect, the second melt flow index is less than the first melt flow index.

In one aspect, the base material has a third melt flow index that is greater than both the first melt flow index and the second melt flow index. In one aspect, the base material can have a third Mooney viscosity that is less than both the first Mooney viscosity and the second Mooney viscosity.

In one example, the second melt flow index is at least 5% different than the first melt flow index. In another example, the second Mooney viscosity is at least 5% different than the first Mooney viscosity. In another example, the base composition can have a Mooney viscosity or a melt flow index that is at least 5% different than both the first and second Mooney viscosities or the first and second melt flow indices.

The composition can include a first percentage by weight (wt %) of the first color concentrate, and a second percentage by weight of the second color concentrate, and the first percentage by weight and the second percentage by weight can be different. In another aspect, the first percentage by weight and the second percentage by weight can be identical.

In one example, the composition can be provided in the core, and the first percentage by weight can be 0.1 wt %-1.0 wt %, and the second percentage by weight can be 0.1 wt %-1.0 wt %.

In another example, the composition can be provided in the intermediate layer or the cover, and the first percentage by weight can be 0.1 wt %-10.0 wt %, and the second percentage by weight can be 0.1 wt %-10.0 wt %.

In one aspect, a ratio of the first percentage by weight to the second percentage by weight can be 2:1, 3:1, 4:1, or more than 5:1. In one aspect, a ratio of the second percentage by weight to the first percentage by weight can be 2:1, 3:1, 4:1, or more than 5:1. One of ordinary skill in the art would understand that the ratio of the first and second color concentrate additives can vary depending on the desired profile of the golf ball.

In another aspect, a golf ball is provided that includes a core, and at least one layer disposed about the core. The at least one layer can comprise a casing or a cover. The at least one layer can have a composition comprising: a base comprised of polyurethane, polyurea, hybrid of polyurethane-polyurea, or ionomer; a first color concentrate additive having a first color; and a second color concentrate additive having a second color. In one aspect, the first color concentrate additive has a first melt flow index and the second color concentrate additive has a second melt flow index that is different than the first melt flow index. In another aspect, the first color concentrate additive has a first Mooney viscosity and the second color concentrate additive has a second Mooney viscosity that is different than the first Mooney viscosity. The first color and the second color can each be separately visible in the at least one layer such that the first and second color concentrate additives are configured to form a marbled pattern in the composition.

The first color concentrate additive can be white and the second color concentrate additive can be non-white, in one example. In another example, the first color concentrate additive can be a first non-white color, and the second color concentrate additive can be a second non-white color.

The first color concentrate additive can be configured to flow using the ASTM D1238 testing standard with a testing temperature, and a testing mass, and the second color concentrate additive can be configured such that it does not flow using the ASTM D1238 testing standard with the testing temperature and the testing mass.

In another aspect, a golf ball is provided that includes a core having a composition comprising a rubber base material (such as a thermoset rubber base), a first color concentrate additive having a first color, and a second color concentrate additive having a second color. A cover, or any other type of outer layer, can be disposed about the core. In one aspect, the first color concentrate additive can have a first melt flow index and the second color concentrate additive can have a second melt flow index that is different than the first melt flow index. In another aspect, the first color concentrate additive can have a first Mooney viscosity and the second color concentrate additive can have a second Mooney viscosity that is different than the first Mooney viscosity. The first color and the second color can each be separately visible in the core and the first and second color concentrate additives can be configured to form a marbled pattern in the composition.

The rubber base material of the core can have a third Mooney viscosity that is less than the first Mooney viscosity and the second Mooney viscosity. The first color concentrate additive can be white, and the second color concentrate additive can be non-white. In one aspect, the first Mooney viscosity is at least 5% different than the second Mooney viscosity.

Various other aspects and embodiments are disclosed here.

### BRIEF DESCRIPTION OF THE DRAWINGS

Further features and advantages of the present disclosure can be ascertained from the following detailed description that is provided in connection with the drawings described below:

FIG. 1A is a cross-sectional view of a two-piece golf ball in accordance with one example.

FIG. 1B is a cross-sectional view of a three-piece golf ball in accordance with another example.

FIG. 1C is a cross-sectional view of a four-piece golf ball in accordance with another example.

FIG. 1D is a cross-sectional view of a five-piece golf ball in accordance with another example.

FIG. 2A is an image of a golf ball according to a first example of the present disclosure.

FIG. 2B is an image of a golf ball according to a second example of the present disclosure.

FIG. 2C is an image of a golf ball according to a third example of the present disclosure.

### DETAILED DESCRIPTION OF THE INVENTION

According to one aspect, a golf ball is disclosed herein that can include inherent design characteristics, such as colors, patterns, or other appearance features, that are formed integrally during the formation of at least one of the core, intermediate layer(s), the casing, or the cover. In one aspect, this feature provides the ability to produce golf balls having unique and/or artistic designs, patterns, colors, etc., while avoiding issues that can occur using traditional methods of painting or spraying an exterior surface of the cover.

In one aspect, at least one color concentrate additive is used within at least one portion or layer of the golf ball. Multiple, different color concentrate additives can be used. The color concentrate additives can be provided in a form that is appropriate for the specific portion of the golf ball in which the color concentrate additives are being incorporated. For example, the color concentrate additives can be provided as pellets, masterbatches, powders, etc. One of ordinary skill in the art would understand that the form of the color concentrate additive can vary. For example, the type of color concentrates for the core can be different than the type of color concentrates for the cover.

The color concentrate additives can be semi-immiscible. In one aspect, the two different color concentrate additives are configured to fully mix with a base material or composition, but the two color concentrate additives do not form a homogeneous mixture with each other due to inherently different physical characteristics, such as melt flow indices or Mooney viscosities. For example, the first color concentrate additive can melt more quickly than the second color concentrate additive such that during a forming process, the first color concentrate additive will disperse to a greater degree within the base material, while the second color concentrate additive will not disperse to the same degree as the first color concentrate additive. In another example, the first color concentrate additive can be mixed, blended, or ground more finely than the second color concentrate additive such that during a forming, mixing, or curing process, the first color concentrate additive is configured to disperse to a greater degree within the base material, while the second color concentrate additive will not disperse to the same degree as the first color concentrate additive. The difference in the dispersion rates based on the different material properties of the color concentrate additives provides a unique and spontaneous pattern in the golf ball component. Due to the inherently uncontrollable factors associated with different materials mixing with each other, the resulting golf ball components have a unique pattern, even when multiple golf ball components are batch processed using identical forming, curing and mixing steps.

If the color concentrate additives are incorporated into a layer or portion of the golf ball that is arranged inward from the outermost portion of the golf ball, i.e., the cover, then the outer layer and any other intermediary layers can be clear, translucent, or transparent such that the color concentrate additives are visible from an exterior of the golf ball.

The color concentrate additives can have two different colors, in one example. The two different colors can be measured as by the CIELAB color space. In one aspect, the color concentrate additives can have colors that are at least 5 units different from each other along the a*-axis, b*-axis, or L*-axis of the CIELAB color space. In one aspect, the color concentrate additives can have colors that are at least 10 units different from each other along the a*-axis, b*-axis, or L*-axis of the CIELAB color space. In one aspect, the color concentrate additives can have colors that are at least 20 units different from each other along the a*-axis, b*-axis, or L*-axis of the CIELAB color space. One of ordinary skill in the art would understand that different colors can refer to completely different colors, such as red & blue, green & pink, white & blue, or shades or variants of a single color, such as royal blue & powder blue. In one aspect, the first and second color concentrate additives can have colors that are visually different.

The color concentrate additives can have different material properties, such as different melt flow indices, different Mooney viscosities, colors, densities, specific gravities, etc. These are described in more detail herein.

In one aspect, a golf ball is disclosed that includes a core, a casing surrounding the core, and a cover surrounding the casing. At least one of the casing or the cover has a composition comprising: a thermoplastic or ionomer base, a first color concentrate additive, and a second color concentrate additive. The first color concentrate additive can have a first melt flow index, and the second color concentrate additive can have a second melt flow index that is different than the first melt flow index. The melt flow indices can be sufficiently different that an appreciable and discernable difference in the melt flow index of the color concentrate additives manifests during formation and/or curing techniques.

In one example, the first color concentrate additive is white, and the second color concentrate additive is non-white. Alternatively, the first color concentrate additive is non-white, and the second color concentrate additive is white. Alternatively, both the first and second color concentrate additives can be non-white.

In one example, the second melt flow index can be less than the first melt flow index. The second melt flow index can be at least 50% less than the first melt flow index, in one example. The second melt flow index can be at least 75% less than the first melt flow index, in one example. In one aspect, the second melt flow index is no greater than 5% less than the first melt flow index.

In one aspect, the second melt flow index is no greater than 5% different than the first melt flow index. In one aspect, the second melt flow index is at least 5% different than the first melt flow index. In one aspect, the second melt flow index is at least 50% different than the first melt flow index. In one aspect, the second melt flow index is at least 100% different than the first melt flow index.

In one example, the first and second melt flow indices are categorically distinct such that a single common testing methodology cannot be used to measure both melt flow indices. In one example, the first melt flow index can be determined using a testing standard with a testing temperature and a testing mass, while the second melt flow index cannot be ascertained using the same testing methodology because the second color concentrate additive does not flow under these testing conditions. In one example, the testing standard is ASTM D1238. In one example, the testing temperature is 235° C. and the testing mass is 8.7 kg. One of ordinary skill in the art would understand that the testing criterion can differ. In another aspect, the second melt flow index can be determined using the ASTM D1238 testing standard with a testing temperature and a testing mass, while the first melt flow index cannot be ascertained using the same testing methodology because the first color concentrate additive does not flow under these testing conditions. In another aspect, the second melt flow index can be determined using the ISO 1133 testing standard with a testing temperature and a testing mass, while the first melt flow index cannot be ascertained using the same testing methodology because the first color concentrate additive does not flow under these testing conditions.

In another example, the casing can have the composition comprising the thermoplastic or ionomer base, the first color concentrate additive, and the second color concentrate additive, and the cover can be transparent such that the mixing of the first and second color concentrate additives is visible through the cover.

The cover can have the composition comprising the thermoplastic or ionomer base, the first color concentrate additive, and the second color concentrate additive.

The thermoplastic or ionomer base can have a third melt flow index that is less than or greater than both the first melt flow index and the second melt flow index.

In another example, a golf ball is disclosed that includes a core having a composition comprising a thermoset rubber base, a first color concentrate additive, and a second color concentrate additive. A casing surrounds the core, and a cover surrounds the casing. The first color concentrate additive can have a first Mooney viscosity, and the second color concentrate additive can have a second Mooney viscosity that is different than the first Mooney viscosity. The casing and the cover can be transparent. The thermoset rubber base of the core can have a third Mooney viscosity that is less than the first Mooney viscosity and the second Mooney viscosity. The first color concentrate additive can be white, and the second color concentrate additive can be non-white.

In yet another example, a golf ball is disclosed herein that includes a core and a cover surrounding the core. The cover can have a composition comprising: a thermoplastic or ionomer base, a first color concentrate additive, and a second color concentrate additive. The first color concentrate additive can have a first melt flow index, and the second color concentrate additive can have a second melt flow index that is different than the first melt flow index.

In another aspect, a method of forming a golf ball component is disclosed. The golf ball component can include any sub-component, sub-assembly, layer, or other portion of the golf ball. The method can comprise forming at least one of a core, an intermediate layer, or a cover from a composition including a base material, a first color concentrate additive having a first color, and a second color concentrate additive having a second color. In one aspect, the first color concentrate additive can have a first melt flow index and the second color concentrate additive can have a second melt flow index that is different than the first melt flow index. In another aspect, the first color concentrate additive can have a first Mooney viscosity and the second color concentrate additive can have a second Mooney viscosity that is different than the first Mooney viscosity. After forming the golf ball component, the first color and the second color are each separately visible in the core, the intermediate layer, or the cover. The first and second color concentrate additives are configured to form a marbled pattern in the composition.

In one aspect, the first color concentrate additive is configured to flow using a testing standard with a testing temperature and a testing mass, and the second color concentrate additive does not flow using the testing standard with the testing temperature and the testing mass.

In one aspect, the second melt flow index is less than the first melt flow index. In another aspect, the second melt flow index is greater than the first melt flow index.

In one aspect, the base material has a third melt flow index that is greater than both the first melt flow index and the second melt flow index. In one aspect, the base material flows more freely or fluidly at a specific curing or formation temperature as compared to the first and second color concentrate additives. In one aspect, the base material can have a third Mooney viscosity that is less than both the first Mooney viscosity and the second Mooney viscosity. In one aspect, the base material mixes more freely or fluidly at a specific grinding step or processing step for forming the golf ball component as compared to the first and second color concentrate additives.

In one example, the second melt flow index is at least 5% different than the first melt flow index. In another example, the second Mooney viscosity is at least 5% different than the first Mooney viscosity.

The composition can include a first percentage by weight of the first color concentrate, and a second percentage by weight of the second color concentrate, and the first percentage by weight and the second percentage by weight can be different. In another aspect, the first percentage by weight and the second percentage by weight can be identical.

In one aspect, the composition can be provided in the core, and the first percentage by weight can be 0.1 wt %-1.0 wt %, and the second percentage by weight can be 0.1 wt %-1.0 wt %. In another aspect, the composition can be in the intermediate layer or the cover, and the first percentage by weight can be 0.1 wt %-10.0 wt %, and the second percentage by weight can be 0.1 wt %-10.0 wt %. One of ordinary skill in the art would understand that these values can differ. The first and second percentage by weight can be at least 10.0 wt %, 20.0 wt %, 30.0 wt %, or more.

In another aspect, a golf ball is provided that includes a core, and at least one layer disposed about the core. The at least one layer can comprise a casing or a cover. The at least one layer can have a composition comprising: a base comprised of polyurethane, polyurea, hybrid of polyurethane-polyurea, or ionomer; a first color concentrate additive having a first color; and a second color concentrate additive having a second color. In one aspect, the first color concentrate additive has a first melt flow index and the second color concentrate additive has a second melt flow index that is different than the first melt flow index. In another aspect, the first color concentrate additive has a first Mooney viscosity and the second color concentrate additive has a second Mooney viscosity that is different than the first Mooney viscosity. The first color and the second color can each be separately visible in the at least one layer such that the first and second color concentrate additives are configured to form a marbled pattern in the composition.

The first color concentrate additive can be white and the second color concentrate additive can be non-white, in one example. In another example, the first color concentrate additive can be a first non-white color, and the second color concentrate additive can be a second non-white color.

The first color concentrate additive can be configured to flow using a testing standard with a testing temperature, and a testing mass, and the second color concentrate additive can be configured such that it does not flow using the testing standard with the testing temperature and the testing mass. The second melt flow index can be at least 5% different than the first melt flow index, in one example.

In another aspect, a golf ball is provided that includes a core having a composition comprising a thermoset rubber base, a first color concentrate additive having a first color, and a second color concentrate additive having a second color. A cover, or any other type of outer layer, can be disposed about the core. In one aspect, the first color concentrate additive can have a first melt flow index and the second color concentrate additive can have a second melt flow index that is different than the first melt flow index. In another aspect, the first color concentrate additive can have a first Mooney viscosity and the second color concentrate additive can have a second Mooney viscosity that is different than the first Mooney viscosity. The first color and the second color can each be separately visible in the core and the first and second color concentrate additives can be configured to form a marbled pattern in the composition. In one aspect, the golf ball component's appearance consists of at least the first color, the second color, and a random, large quantity of additional colors (i.e., gradations of the first and second colors). Dozens, hundreds, thousands, or more shades generated by the partial mixing of the first and second colors can manifest in the golf ball component.

The thermoset rubber base of the core can have a third Mooney viscosity that is less than the first Mooney viscosity and the second Mooney viscosity. The first color concentrate additive can be white, and the second color concentrate additive can be non-white. In one aspect, the first Mooney viscosity is at least 5% different than the second Mooney viscosity.

### Core Formulations

Concentrations of components are in parts per hundred (phr) unless otherwise indicated. As used herein, the term, “parts per hundred,” also known as “phr” or “pph” is defined as the number of parts by weight of a particular component present in a mixture, relative to 100 parts by weight of the polymer component. Mathematically, this can be expressed as the weight of an ingredient divided by the total weight of the polymer, multiplied by a factor of 100.

### Base Rubber

The core rubber formulations of the present disclosure can include a base rubber. In some embodiments, the base rubber may include natural and synthetic rubbers and combinations of two or more thereof. Examples of natural and synthetic rubbers suitable for use as the base rubber include, but are not limited to, polybutadiene, polyisoprene, ethylene propylene rubber (EPR), ethylene-propylene-diene (EPDM) rubber, grafted EPDM rubber, styrene-butadiene rubber, styrenic block copolymer rubbers (such as “SI”, “SIS”, “SB”, “SBS”, “SIBS”, and the like, where “S” is styrene, “I” is isobutylene, and “B” is butadiene), polyalkenamers such as, for example, polyoctenamer, butyl rubber, halobutyl rubber, polystyrene elastomers, polyethylene elastomers, polyurethane elastomers, polyurea elastomers, metallocene-catalyzed elastomers and plastomers, copolymers of isobutylene and p-alkylstyrene, halogenated copolymers of isobutylene and p-alkylstyrene, copolymers of butadiene with acrylonitrile, polychloroprene, alkyl acrylate rubber, chlorinated isoprene rubber, acrylonitrile chlorinated isoprene rubber, and combinations of two or more thereof.

For example, the core may be formed from a rubber formulation that includes polybutadiene as the base rubber. Polybutadiene is a homopolymer of 1,3-butadiene. The double bonds in the 1,3-butadiene monomer are attacked by catalysts to grow the polymer chain and form a polybutadiene polymer having a desired molecular weight. Any suitable catalyst may be used to synthesize the polybutadiene rubber depending upon the desired properties. In one embodiment, a transition metal complex (for example, neodymium, nickel, or cobalt) or an alkyl metal such as alkyl lithium is used as a catalyst. Other catalysts include, but are not limited to, aluminum, boron, lithium, titanium, and combinations thereof. The catalysts produce polybutadiene rubbers having different chemical structures. In a cis-bond configuration, the main internal polymer chain of the polybutadiene appears on the same side of the carbon-carbon double bond contained in the polybutadiene. In a trans-bond configuration, the main internal polymer chain is on opposite sides of the internal carbon-carbon double bond in the polybutadiene. The polybutadiene rubber can have various combinations of cis- and trans-bond structures. For example, the polybutadiene rubber may have a 1,4 cis-bond content of at least 40 percent. In another embodiment, the polybutadiene rubber has a 1,4 cis-bond content of greater than 80 percent. In still another embodiment, the polybutadiene rubber has a 1,4 cis-bond content of greater than 90 percent. In general, polybutadiene rubbers having a high 1,4 cis-bond content have high tensile strength and rebound.

The polybutadiene rubber may have a relatively high or low Mooney viscosity. Generally, polybutadiene rubbers of higher molecular weight and higher Mooney viscosity have better resiliency than polybutadiene rubbers of lower molecular weight and lower Mooney viscosity. However, as the Mooney viscosity increases, the milling and processing of the polybutadiene rubber generally becomes more difficult. Blends of high and low Mooney viscosity polybutadiene rubbers may be prepared as is described in U.S. Pat. Nos. 6,982,301 and 6,774,187, the disclosures of which are hereby incorporated by reference, and used in accordance with the present disclosure. In general, the lower limit of Mooney viscosity may be about 30 or 35 or 40 or 45 or 50 or 55 or 60 or 70 or 75 and the upper limit may be about 80 or 85 or 90 or 95 or 100 or 105 or 110 or 115 or 120 or 125 or 130. For example, the polybutadiene used in the rubber formulation may have a Mooney viscosity of about 30 to about 80 or about 40 to about 60.

Examples of commercially available polybutadiene rubbers that can be used in rubber formulations in accordance with the present disclosure, include, but are not limited to, BR 01 and BR 1220, available from BST Elastomers of Bangkok, Thailand; SE BR 1220LA and SE BR1203, available from DOW Chemical Co of Midland, Mich.; BUDENE 1207, 1207s, 1208, and 1280 available from Goodyear, Inc of Akron, Ohio; BR 01, 51 and 730, available from Japan Synthetic Rubber (JSR) of Tokyo, Japan; BUNA CB 21, CB 22, CB 23, CB 24, CB 25, CB 29 MES, CB 60, CB Nd 60, CB 55 NF, CB 70 B, CB KA 8967, and CB 1221, available from Lanxess Corp. of Pittsburgh. Pa.; BR1208, available from LG Chemical of Seoul, South Korea; UBEPOL BR130B, BR150, BR150B, BR150L, BR230, BR360L, BR710, and VCR617, available from UBE Industries, Ltd. of Tokyo, Japan; EUROPRENE NEOCIS BR 60, INTENE 60 AF and P30AF, and EUROPRENE BR HV80, available from Polimeri Europa of Rome, Italy; KBR 01, NdBr 40, NdBR-45, NdBr 60, KBR 710S, KBR 710H, and KBR 750, available from Kumho Petrochemical Co., Ltd. Of Seoul, South Korea; DIENE 55NF, 70AC, and 320 AC, available from Firestone Polymers of Akron, Ohio; and PBR-Nd Group II and Group III, available from Nizhnekamskneftekhim, Inc. of Nizhnekamsk, Tartarstan Republic.

In another embodiment, the core is formed from a rubber formulation including butyl rubber. Butyl rubber is an elastomeric copolymer of isobutylene and isoprene. Butyl rubber is an amorphous, non-polar polymer with good oxidative and thermal stability, good permanent flexibility, and high moisture and gas resistance. Generally, butyl rubber includes copolymers of about 70 percent to about 99.5 percent by weight of an isoolefin, which has about 4 to 7 carbon atoms, for example, isobutylene, and about 0.5 percent to about 30 percent by weight of a conjugated multiolefin, which has about 4 to 14 carbon atoms, for example, isoprene. The resulting copolymer contains about 85 percent to about 99.8 percent by weight of combined isoolefin and about 0.2 percent to about 15 percent of combined multiolefin. A commercially available butyl rubber suitable for use in rubber formulations in accordance with the present disclosure includes Bayer Butyl 301 manufactured by Bayer AG.

The rubber formulations may include a combination of two or more of the above-described rubbers as the base rubber. In some embodiments, the rubber formulation of the present disclosure includes a blend of different polybutadiene rubbers. In this embodiment, the rubber formulation may include a blend of a first polybutadiene rubber and a second polybutadiene rubber in a ratio of about 5:95 to about 95:5. For example, the rubber formulation may include a first polybutadiene rubber and a second polybutadiene rubber in a ratio of about 10:90 to about 90:10 or about 15:85 to about 85:15 or about 20:80 to about 80:20 or about 30:70 to about 70:30 or about 40:60 to about 60:40. In other embodiments, the rubber formulation may include a blend of more than two polybutadiene rubbers or a blend of polybutadiene rubber(s) with any of the other elastomers discussed above.

In further embodiments, the rubber formulation used to form the core can include a blend of polybutadiene and EPDM rubber or grafted EPDM rubber as the base rubber. In still further embodiments, the rubber formulations may include a combination of polybutadiene rubber and EPDM rubber as the base rubber. In this embodiment, the EPDM may be included in the rubber formulation in an amount of about 0.1 to about 20 or about 1 to about 15 or about 3 to about 10 parts by weight per 100 parts of the total rubber. For example, EPDM may be included in the rubber formulation in an amount of about 5 parts by weight per 100 parts of the total rubber. In still further embodiments, the core formulations may combine EPDM rubber and two or more different types of polybutadiene rubber, such as two or more different types of high cis-1,4 polybutadiene, as the base rubber.

The rubber formulations include the base rubber in an amount of 100 phr. That is, when more than one rubber component is used in the rubber formulation as the base rubber, the sum of the amounts of each rubber component should total 100 phr. In some embodiments, the rubber formulations include polybutadiene rubber as the base rubber in an amount of 100 phr. In other embodiments, the rubber formulations include polybutadiene rubber and a second rubber component. In this embodiment, the polybutadiene rubber may be used in an amount of about 80 to about 99.9 parts by weight per 100 parts of the total rubber and the second rubber component may be used in an amount of about 0.1 to about 20 parts by weight per 100 parts of the total rubber. In further embodiments, the polybutadiene rubber may be used in an amount of about 85 to about 99 parts by weight per 100 parts of the total rubber and the second rubber component may be used in an amount of about 1 to about 15 parts by weight per 100 parts of the total rubber. In yet other embodiments, the polybutadiene rubber may be used in an amount of about 90 to about 97 parts by weight per 100 parts of the total rubber and the second rubber component may be used in an amount of about 3 to about 10 parts by weight per 100 parts of the total rubber. In still further embodiments, the polybutadiene rubber may be used in an amount of about 94 to about 96 parts by weight per 100 parts of the total rubber and the second rubber component may be used in an amount of about 4 to about 6 parts by weight per 100 parts of the total rubber.

The base rubber may be used in the rubber formulation in an amount of at least about 5 percent by weight based on total weight of the rubber formulation. In some embodiments, the base rubber is included in the rubber formulation in an amount within a range having a lower limit of about 10 percent or 20 percent or 30 percent or 40 percent or 50 percent or 55 percent and an upper limit of about 60 percent or 70 percent or 80 percent or 90 percent or 95 percent or 100 percent. For example, the base rubber may be present in the rubber formulation in an amount of about 30 percent to about 80 percent by weight based on the total weight of the rubber formulation. In another example, the rubber formulation includes about 40 percent to about 70 percent base rubber based on the total weight of the rubber formulation.

### Crosslinking Co-Agent

The rubber formulations can further include a reactive cross-linking co-agent. Suitable co-agents include, but are not limited to, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. In one embodiment, the co-agent is one or more metal salts of acrylates, diacrylates, methacrylates, and dimethacrylates, wherein the metal is selected from magnesium, calcium, zinc, aluminum, lithium, and nickel. In another embodiment, the co-agent includes one or more zinc salts of acrylates, diacrylates, methacrylates, and dimethacrylates. For example, the co-agent may be zinc diacrylate (ZDA). In another embodiment, the co-agent may be zinc dimethacrylate (ZDMA). An example of a commercially available zinc diacrylate includes Dymalink® 526 manufactured by Cray Valley.

The co-agent may be included in the rubber formulation in varying amounts depending on the desired characteristics of the golf ball core. For example, the co-agent may be used in an amount of about 5 to about 50 or about 10 to about 45 or about 15 to about 40 parts by weight per 100 parts of the total rubber. In one embodiment, the rubber formulation of the core includes about 35 to about 48 parts by weight co-agent per 100 parts of the total rubber. In another embodiment, the rubber formulation includes about 38 to about 45 or about 39 to about 42 parts by weight co-agent per 100 parts of total rubber. In another embodiment, the co-agent is included in the rubber formulation of the core in an amount of about 29 to about 37 or about 31 to about 35 parts by weight per 100 parts of the total rubber. In still another embodiment, the rubber formulation includes about 25 to about 33 or about 27 to about 31 parts by weight co-agent per 100 parts of the total rubber. In yet another example, the co-agent may be used in an amount of about 20-40 parts by weight per 100 parts of the total rubber. In one example, the co-agent is used in an amount of about 30 to 35 parts by weight per 100 parts of the total rubber.

### Free Radical Initiator

The core formulations may include a free radical initiator selected from an organic peroxide, a high energy radiation source capable of generating free radicals, or a combination thereof. Suitable organic peroxides include, but are not limited to, dicumyl peroxide; n-butyl-4,4-di(t-butylperoxy) valerate; 1,1-di(t-butylperoxy) 3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy) hexyne-3; di(2-t-butyl-peroxyisopropyl)benzene; dilauroyl peroxide; dibenzoyl peroxide; t-butyl hydroperoxide; and combinations thereof. In a particular embodiment, the free radical initiator is dicumyl peroxide, including, but not limited to Perkadox® BD-FF, commercially available from Akzo Nobel. In other embodiments, the free radical initiator is dimethyl terbutyl peroxide, including, but not limited to Trigonox® 101-50D-PD, commercially available from Nouryon.

Free radical initiators may be present in the rubber formulation in an amount of at least 0.05 parts by weight per 100 parts of the total rubber, or an amount within the range having a lower limit of 0.05 parts or 0.1 parts or 1 part or 1.25 parts or 1.5 parts or 2.5 parts or 5 parts by weight per 100 parts of the total rubber, and an upper limit of 2.5 parts or 3 parts or 5 parts or 6 parts or 10 parts or 15 parts by weight per 100 parts of the total rubber. For example, the rubber formulation may include peroxide free radical initiators in an amount of about 0.1 to about 10 or about 0.5 to about 6 or about 1 to about 5 parts by weight per 100 parts of the total rubber. In another example, the rubber formulation may include peroxide free radical initiators in an amount of about 0.5 to about 2 or about 0.7 to about 1.8 or about 0.8 to about 1.2 or about 1.3 to about 1.7 parts by weight per 100 parts of the total rubber. In yet another example, the rubber formulation may include peroxide free radical initiators in an amount of about 1.5 to about 3 or about 1.7 to about 2.8 or about 1.8 to about 2.2 or about 2.3 to about 2.7 parts by weight per 100 parts of the total rubber.

### Additives

Radical scavengers such as a halogenated organosulfur, organic disulfide, or inorganic disulfide compounds may also be added to the rubber formulation. In one embodiment, a halogenated organosulfur compound included in the rubber formulation includes, but is not limited to, pentachlorothiophenol (PCTP) and salts of PCTP such as zinc pentachlorothiophenol (ZnPCTP). In another embodiment, ditolyl disulfide, diphenyl disulfide, dixylyl disulfide, 2-nitroresorcinol, and combinations thereof are added to the rubber formulation. An example of a commercially available radical scavenger includes Rhenogran® Zn-PTCP-72 manufactured by Rheine Chemie. The radical scavenger may be included in the rubber formulation in an amount of about 0.3 to about 1.0 part by weight per 100 parts of the total rubber. In one embodiment, the rubber formulation may include about 0.4 to about 0.9 parts by weight radical scavenger per 100 parts of the total rubber. In another embodiment, the rubber formulation may include about 0.5 to about 0.8 parts by weight radical scavenger per 100 parts of the total rubber. In another embodiment, the rubber formulation may include about 0.3 parts to about 0.4 parts by weight radical scavenger per 100 parts of the total rubber.

### Fillers

Suitable non-limiting examples of fillers include carbon black, clay and nanoclay particles, talc, glass (e.g., glass flake, milled glass, and microglass), mica and mica-based pigments (e.g., Iriodin® pearl luster pigments from The Merck Group), and combinations thereof. Metal oxide and metal sulfate fillers are also contemplated for inclusion in the rubber formulation. Suitable metal fillers include, for example, particulate, powders, flakes, and fibers of copper, steel, brass, tungsten, titanium, aluminum, magnesium, molybdenum, cobalt, nickel, iron, lead, tin, zinc, barium, bismuth, bronze, silver, gold, and platinum, and alloys and combinations thereof. Suitable metal oxide fillers include, for example, zinc oxide, iron oxide, aluminum oxide, titanium oxide, magnesium oxide, and zirconium oxide. Suitable metal sulfate fillers can include, for example, barium sulfate and/or strontium sulfate. An example of a commercially available barium sulfate filler includes PolyWate® 325 manufactured by Cimbar Performance Minerals.

When included, the fillers may be in an amount of about 1 to about 25 parts by weight per 100 parts of the total rubber. In one embodiment, the rubber formulation includes at least one filler in an amount of about 5 to about 20 or about 8 to about 15 parts by weight per 100 parts of the total rubber. In another embodiment, the rubber formulation includes at least one filler in an amount of about 8 to about 14 or about 10 to about 12 parts by weight per 100 parts of the total rubber. In yet another embodiment, the rubber formulation includes at least one filler in an amount of about 10 to about 17 or about 12 to about 15 parts by weight per 100 parts of the total rubber. In yet another embodiment, the rubber formulation includes at least one filler in an amount of about 10 to about 16 or about 12 to about 15 parts by weight per 100 parts of the total rubber. In a further embodiment, the rubber formulation includes at least one filler in an amount of about 12 to about 18 or about 14 to about 16 parts by weight per 100 parts of the total rubber. In one example, the filler is added to weight for a specific gravity, and the exact values can vary depending on the specific gravity of a specific rubber batch.

In some aspects, the amount of filler in the rubber formulation may be altered based on the compound, and the particular isomer of the compound, used as the hardening agent. For example, when the rubber formulation includes 2-nitrophenol, at least one filler may be included in the rubber formulation in amount from about 9 to about 13 parts by weight per 100 parts of the total rubber. In another example, when the rubber formulation includes 3-nitrophenol, the filler may be included in the rubber formulation in amount from about 11 to about 16 parts by weight per 100 parts of the total rubber. In yet another example, when the rubber formulation includes 4-nitrophenol, the filler may be included in the rubber formulation in amount from about 13 to about 17 parts by weight per 100 parts of the total rubber.

In some embodiments, more than one type of filler may be included in the rubber formulation. For example, the rubber formulation may include a first filler in an amount from about 5 to about 20 or about 8 to about 17 parts by weight per 100 parts total rubber and a second filler in an amount from about 1 to about 10 or about 3 to about 7 parts by weight per 100 parts total rubber. In another example, the rubber formulation may include a first filler in an amount from about 7 to about 13 or about 9 to about 12 parts by weight per 100 parts total rubber and a second filler in an amount from about 2 to about 8 or about 4 to about 6 parts by weight per 100 parts total rubber. In yet another example, the rubber formulation may include a first filler in an amount from about 10 to about 15 or about 13 to about 14 parts by weight per 100 parts total rubber and a second filler in an amount from about 2 to about 9 or about 3 to about 7 parts by weight per 100 parts total rubber. In a further example, the rubber formulation may include a first filler in an amount from about 10 to about 15 or about 13 to about 14 parts by weight per 100 parts total rubber and a second filler in an amount from about 13 to about 18 or about 14 to about 16 parts by weight per 100 parts total rubber.

Antioxidants, processing aids, accelerators (for example, tetra methylthiuram), dyes and pigments, wetting agents, surfactants, plasticizers, coloring agents, fluorescent agents, chemical blowing and foaming agents, defoaming agents, stabilizers, softening agents, impact modifiers, antiozonants, as well as other additives known in the art, may also be added to the rubber formulation. Examples of suitable processing aids include, but are not limited to, high molecular weight organic acids and salts thereof. Suitable organic acids are aliphatic organic acids, aromatic organic acids, saturated mono-functional organic acids, unsaturated monofunctional organic acids, multi-unsaturated mono-functional organic acids, and dimerized derivatives thereof. In one embodiment, the organic acids include, but are not limited to, caproic acid, caprylic acid, capric acid, lauric acid, stearic acid, behenic acid, erucic acid, oleic acid, linoleic acid, myristic acid, benzoic acid, palmitic acid, phenylacetic acid, naphthalenoic acid, and dimerized derivatives thereof. The salts of organic acids include the salts of barium, lithium, sodium, zinc, bismuth, chromium, cobalt, copper, potassium, strontium, titanium, tungsten, magnesium, cesium, iron, nickel, silver, aluminum, tin, or calcium, salts of fatty acids, particularly stearic, behenic, erucic, oleic, linoelic or dimerized derivatives thereof.

### Curing the Core Formulation

The rubber, hardening agent, cross-linking agent, free radical initiator, fillers, and any other materials used in forming the core, in accordance with the present disclosure, may be combined to form a mixture by any type of mixing known to one of ordinary skill in the art. Suitable types of mixing include single pass and multi-pass mixing, and the like. A single pass mixing process where ingredients are added sequentially can be used because this type of mixing tends to increase efficiency and reduce costs for the process. In embodiments where a free-radical initiator is used, it may be desirable to combine the hardening agent into the rubber formulation prior to adding the free-radical initiator.

The rubber formulation may be cured using conventional curing processes. Non-limiting examples of curing processes suitable for use in accordance with the present disclosure include peroxide-curing, sulfur-curing, high-energy radiation, and combinations thereof.

The golf balls of the present disclosure may be formed using a variety of application techniques. For example, the golf ball, golf ball core, or any layer of the golf ball may be formed using compression molding, flip molding, injection molding, retractable pin injection molding, reaction injection molding (RIM), liquid injection molding (LIM), casting, vacuum forming, powder coating, flow coating, spin coating, dipping, spraying, and the like. Conventionally, compression molding and injection molding are applied to thermoplastic materials, whereas RIM, liquid injection molding, and casting are employed on thermoset materials. In this aspect, cover layers may be formed over the core using any suitable technique that is associated with the material used to form the layer. Preferably, each cover layer is separately formed over the core. For example, an ethylene acid copolymer ionomer composition may be injection-molded to produce half-shells over the core. Alternatively, the ionomer composition can be placed into a compression mold and molded under sufficient pressure, temperature, and time to produce the hemispherical shells, which may then be placed around the core in a compression mold. An outer cover layer including a polyurethane or polyurea composition over the ball sub-assembly may be formed by using a casting process.

The rubber formulations discussed above are suitable for use in the core or one or more of the core layers if multiple core layers are present. It is also contemplated that the rubber formulations disclosed herein may be used to form one or more of the layers of any of the one, two, three, four, or five, or more-piece (layered) golf balls described above. That is, any of the core layers, intermediate layers, and/or cover layers may comprise the rubber formulation of this disclosure. The rubber formulations of different layers may be the same or different. The diameter and thickness of the different layers along with properties such as hardness and compression may vary depending upon the construction and desired playing performance properties of the golf ball.

### Cover

In one aspect, different materials may be used in the construction of the intermediate and cover layers of golf balls according to the present disclosure. For example, a variety of materials may be used for forming the outer cover including, for example, polyurethanes; polyureas; copolymers, blends and hybrids of polyurethane and polyurea; olefin-based copolymer ionomer resins; polyethylene, including, for example, low density polyethylene, linear low density polyethylene, and high density polyethylene; polypropylene; rubber-toughened olefin polymers; acid copolymers, for example, poly(meth)acrylic acid, which do not become part of an ionomeric copolymer; plastomers; flexomers; styrene/butadiene/styrene block copolymers; styrene/ethylene-butylene/styrene block copolymers; dynamically vulcanized elastomers; copolymers of ethylene and vinyl acetates; copolymers of ethylene and methyl acrylates; polyvinyl chloride resins; polyamides, poly(amide-ester) elastomers, and graft copolymers of ionomer; cross-linked trans-polyisoprene and blends thereof; polyester-based thermoplastic elastomers; polyurethane-based thermoplastic elastomers; synthetic or natural vulcanized rubber; and combinations thereof.

In one embodiment, the cover is formed from a polyurethane, polyurea, or hybrid of polyurethane-polyurea. When used as cover layer materials, polyurethanes and polyureas can be thermoset or thermoplastic. Thermoset materials can be formed into golf ball layers by conventional casting or reaction injection molding techniques. Thermoplastic materials can be formed into golf ball layers by conventional compression or injection molding techniques.

Conventional and non-conventional materials may be used for forming intermediate layers of the ball including, for instance, ionomer resins, highly neutralized polymers, polybutadiene, butyl rubber, and other rubber-based core formulations, and the like. In one embodiment, the inner cover layer, i.e., the layer disposed between the core and the outer cover, includes an ionomer. In this aspect, ionomers suitable for use in accordance with the present disclosure may include partially neutralized ionomers and highly neutralized ionomers (HNPs), including ionomers formed from blends of two or more partially-neutralized ionomers, blends of two or more highly-neutralized ionomers, and blends of one or more partially-neutralized ionomers with one or more highly-neutralized ionomers. For purposes of the present disclosure, “HNP” refers to an acid copolymer after at least 70 percent of all acid groups present in the composition are neutralized.

Preferred ionomers are salts of O/X- and O/X/Y-type acid copolymers, wherein O is an α-olefin, X is a C₃-C₈ α, β-ethylenically unsaturated carboxylic acid, and Y is a softening monomer. O is preferably selected from ethylene and propylene. X is preferably selected from methacrylic acid, acrylic acid, ethacrylic acid, crotonic acid, and itaconic acid. Methacrylic acid and acrylic acid are particularly preferred. Y is preferably selected from (meth) acrylate and alkyl (meth) acrylates wherein the alkyl groups have from 1 to 8 carbon atoms, including, but not limited to, n-butyl (meth) acrylate, isobutyl (meth) acrylate, methyl (meth) acrylate, and ethyl (meth) acrylate.

Preferred O/X and O/X/Y-type copolymers include, without limitation, ethylene acid copolymers, such as ethylene/(meth)acrylic acid, ethylene/(meth)acrylic acid/maleic anhydride, ethylene/(meth)acrylic acid/maleic acid mono-ester, ethylene/maleic acid, ethylene/maleic acid mono-ester, ethylene/(meth)acrylic acid/n-butyl (meth)acrylate, ethylene/(meth)acrylic acid/iso-butyl (meth)acrylate, ethylene/(meth)acrylic acid/methyl (meth)acrylate, ethylene/(meth)acrylic acid/ethyl (meth)acrylate terpolymers, and the like. The term, “copolymer,” as used herein, includes polymers having two types of monomers, those having three types of monomers, and those having more than three types of monomers. Preferred α, B-ethylenically unsaturated mono- or dicarboxylic acids are (meth) acrylic acid, ethacrylic acid, maleic acid, crotonic acid, fumaric acid, itaconic acid. (Meth) acrylic acid is most preferred. As used herein, “(meth) acrylic acid” means methacrylic acid and/or acrylic acid. Likewise, “(meth) acrylate” means methacrylate and/or acrylate.

In a particularly preferred version, highly neutralized E/X- and E/X/Y-type acid copolymers, wherein E is ethylene, X is a C₃-C₈ α, β-ethylenically unsaturated carboxylic acid, and Y is a softening monomer are used. X is preferably selected from methacrylic acid, acrylic acid, ethacrylic acid, crotonic acid, and itaconic acid. Methacrylic acid and acrylic acid are particularly preferred. Y is preferably an acrylate selected from alkyl acrylates and aryl acrylates and preferably selected from (meth) acrylate and alkyl (meth) acrylates wherein the alkyl groups have from 1 to 8 carbon atoms, including, but not limited to, n-butyl (meth) acrylate, isobutyl (meth) acrylate, methyl (meth) acrylate, and ethyl (meth) acrylate. Preferred E/X/Y-type copolymers are those wherein X is (meth) acrylic acid and/or Y is selected from (meth) acrylate, n-butyl (meth) acrylate, isobutyl (meth) acrylate, methyl (meth) acrylate, and ethyl (meth) acrylate. More preferred E/X/Y-type copolymers are ethylene/(meth) acrylic acid/n-butyl acrylate, ethylene/(meth) acrylic acid/methyl acrylate, and ethylene/(meth) acrylic acid/ethyl acrylate.

The amount of ethylene in the acid copolymer may be at least about 15 weight percent, at least about 25 weight percent, at least about 40 weight percent, or at least about 60 weight percent, based on total weight of the copolymer. The amount of C₃ to C₈ α, β-ethylenically unsaturated mono- or dicarboxylic acid in the acid copolymer is typically from 1 weight percent to 35 weight percent, from 5 weight percent to 30 weight percent, from 5 weight percent to 25 weight percent, or from 10 weight percent to 20 weight percent, based on total weight of the copolymer. The amount of optional softening comonomer in the acid copolymer may be from 0 weight percent to 50 weight percent, from 5 weight percent to 40 weight percent, from 10 weight percent to 35 weight percent, or from 20 weight percent to 30 weight percent, based on total weight of the copolymer.

The various O/X, E/X, O/X/Y, and E/X/Y-type copolymers are at least partially neutralized with a cation source, optionally in the presence of a high molecular weight organic acid, such as those disclosed in U.S. Pat. No. 6,756,436, the entire disclosure of which is hereby incorporated herein by reference. The acid copolymer can be reacted with the optional high molecular weight organic acid and the cation source simultaneously, or prior to the addition of the cation source. Suitable cation sources include, but are not limited to, metal ion sources, such as compounds of alkali metals, alkaline earth metals, transition metals, and rare earth elements; ammonium salts and monoamine salts; and combinations thereof. Preferred cation sources are compounds of magnesium, sodium, potassium, cesium, calcium, barium, manganese, copper, zinc, lead, tin, aluminum, nickel, chromium, lithium, and rare earth metals. The amount of cation used in the composition is readily determined based on desired level of neutralization. As discussed above, for HNP compositions, the acid groups are neutralized to 70 percent or greater, 70 to 100 percent, or 90 to 100 percent. In one embodiment, an excess amount of neutralizing agent, that is, an amount greater than the stoichiometric amount needed to neutralize the acid groups, may be used. That is, the acid groups may be neutralized to 100 percent or greater, for example 110 percent or 120 percent or greater. In other embodiments, partially neutralized compositions are prepared, wherein 10 percent or greater, normally 30 percent or greater of the acid groups are neutralized. When aluminum is used as the cation source, it is preferably used at low levels with another cation such as zinc, sodium, or lithium, since aluminum has a dramatic effect on melt flow reduction and cannot be used alone at high levels. For example, aluminum is used to neutralize about 10 percent of the acid groups and sodium is added to neutralize an additional 90 percent of the acid groups.

“Low acid” and “high acid” ionomeric polymers, as well as blends of such ionomers, may be used. In general, low acid ionomers are considered to be those containing 16 weight percent or less of acid moieties, whereas high acid ionomers are considered to be those containing greater than 16 weight percent of acid moieties. In one embodiment, the inner cover layer is formed from a composition comprising a high acid ionomer. A suitable high acid ionomer is Surlyn® 8150. (Dow), which is a copolymer of ethylene and methacrylic acid, having an acid content of 19 weight percent, 45 percent neutralized with sodium. In another embodiment, the inner cover layer is formed from a composition comprising a high acid ionomer and a maleic anhydride-grafted non-ionomeric polymer. An example of a suitable maleic anhydride-grafted polymer is Fusabond® 525D (Dow), which is a maleic anhydride-grafted, metallocene-catalyzed ethylene-butene copolymer having about 0.9 weight percent maleic anhydride grafted onto the copolymer. Blends of high acid ionomers with maleic anhydride-grafted polymers are further disclosed, for example, in U.S. Pat. Nos. 6,992,135 and 6,677,401, the entire disclosures of which are hereby incorporated herein by reference.

When used to form an inner cover layer, the base polymer may include a composition comprising a 50/45/5 blend of Surlyn® 8940/Surlyn® 9650/Nucrel® 960. In this aspect, the composition may have a material hardness of from 80 to 85 Shore C. In another embodiment, the inner cover layer is formed from a composition comprising a 50/25/25 blend of Surlyn® 8940/Surlyn® 9650/Surlyn® 9910, having a material hardness of about 85 to 95 Shore C. In yet another embodiment, the inner cover layer is formed from a composition comprising a 50/50 blend of Surlyn® 8940/Surlyn® 9650, having a material hardness of about 82 to 90 Shore C. A composition comprising a 50/50 blend of Surlyn® 8940 and Surlyn® 7940 also may be used.

The compositions used to make the layers outside of the core, e.g., the outer cover layer and, when present, the inner cover layer, may contain a variety of fillers and additives to impart specific properties to the ball. For example, relatively heavy-weight and light-weight metal fillers such as, particulate; powders; flakes; and fibers of copper, steel, brass, tungsten, titanium, aluminum, magnesium, molybdenum, cobalt, nickel, iron, lead, tin, zinc, barium, bismuth, bronze, silver, gold, and platinum, and alloys and combinations thereof may be used to adjust the specific gravity of the ball. Other additives and fillers include, but are not limited to, optical brighteners, coloring agents, fluorescent agents, whitening agents, UV absorbers, light stabilizers, surfactants, processing aids, antioxidants, stabilizers, softening agents, fragrance components, plasticizers, impact modifiers, titanium dioxide, clay, mica, talc, glass flakes, milled glass, and mixtures thereof.

The present disclosure is not meant to be limited by the material used to form each layer of the golf ball. Particularly suitable materials include, but are not limited to, thermosetting materials, such as polybutadiene, styrene butadiene, isoprene, polyisoprene, and trans-isoprene; thermoplastics, such as ionomer resins, polyamides and polyesters; and thermoplastic and thermosetting polyurethane and polyureas.

Particularly suitable thermosetting materials, include, but are not limited to, thermosetting rubber compositions comprising a base polymer, an initiator agent, a coagent and/or a curing agent, and optionally one or more of a metal oxide, metal fatty acid or fatty acid, antioxidant, soft and fast agent, fillers, and additives. Suitable base polymers include natural and synthetic rubbers including, but not limited to, polybutadiene, polyisoprene, ethylene propylene rubber (“EPR”), styrene-butadiene rubber, styrenic block copolymer rubbers (such as SI, SIS, SB, SBS, SIBS, and the like, where “S” is styrene, “I” is isobutylene, and “B” is butadiene), butyl rubber, halobutyl rubber, polystyrene elastomers, polyethylene elastomers, polyurethane elastomers, polyurea elastomers, metallocene-catalyzed elastomers and plastomers, copolymers of isobutylene and para-alkylstyrene, halogenated copolymers of isobutylene and para-alkylstyrene, acrylonitrile butadiene rubber, polychloroprene, alkyl acrylate rubber, chlorinated isoprene rubber, acrylonitrile chlorinated isoprene rubber, polyalkenamers, and combinations of two or more thereof. Suitable initiator agents include organic peroxides, high energy radiation sources capable of generating free radicals, C—C initiators, and combinations thereof. Suitable coagents include, but are not limited to, metal salts of unsaturated carboxylic acids; unsaturated vinyl compounds and polyfunctional monomers (e.g., trimethylolpropane trimethacrylate); phenylene bismaleimide; and combinations thereof. Suitable curing agents include, but are not limited to, sulfur; N-oxydiethylene 2-benzothiazole sulfenamide; N,N-di-ortho-tolylguanidine; bismuth dimethyldithiocarbamate; N-cyclohexyl 2-benzothiazole sulfenamide; N,N-diphenylguanidine; 4-morpholinyl-2-benzothiazole disulfide; dipentamethylenethiuram hexasulfide; thiuram disulfides; mercaptobenzothiazoles; sulfenamides; dithiocarbamates; thiuram sulfides; guanidines; thioureas; xanthates; dithiophosphates; aldehyde-amines; dibenzothiazyl disulfide; tetraethylthiuram disulfide; tetrabutylthiuram disulfide; and combinations thereof. Suitable types and amounts of base polymer, initiator agent, coagent, filler, and additives are more fully described in, for example, U.S. Pat. Nos. 6,566,483, 6,695,718, 6,939,907, 7,041,721 and 7,138,460, the entire disclosures of which are hereby incorporated herein by reference. Particularly suitable diene rubber compositions are further disclosed, for example, in U.S. Patent Application Publication No. 2007/0093318, the entire disclosure of which is hereby incorporated herein by reference.

Particularly suitable materials also include, but are not limited to: a) thermosetting polyurethanes, polyureas, and hybrids of polyurethane and polyurea; b) thermoplastic polyurethanes, polyureas, and hybrids of polyurethane and polyurea, including, for example, Estane® TPU, commercially available from The Lubrizol Corporation; c) E/X- and E/X/Y-type ionomers, wherein E is an olefin (e.g., ethylene), X is a carboxylic acid (e.g., acrylic, methacrylic, crotonic, maleic, fumaric, or itaconic acid), and Y is a softening comonomer (e.g., vinyl esters of aliphatic carboxylic acids wherein the acid has from 2 to 10 carbons, alkyl ethers wherein the alkyl group has from 1 to 10 carbons, and alkyl alkylacrylates such as alkyl methacrylates wherein the alkyl group has from 1 to 10 carbons), such as Surlyn® ionomer resins and HPF 1000 and HPF 2000, commercially available from The Dow Chemical Company, Iotek® ionomers, commercially available from ExxonMobil Chemical Company, Amplify® IO ionomers of ethylene acrylic acid copolymers, commercially available from The Dow Chemical Company, and Clarix® ionomer resins, commercially available from A. Schulman Inc.; d) polyisoprene; e) polyoctenamer, such as Vestenamer® polyoctenamer, commercially available from Evonik Industries; f) polyethylene, including, for example, low density polyethylene, linear low density polyethylene, and high density polyethylene; polypropylene; g) rubber-toughened olefin polymers; non-ionomeric acid copolymers, e.g., (meth) acrylic acid, which do not become part of an ionomeric copolymer; h) plastomers; i) flexomers; j) styrene/butadiene/styrene block copolymers; k) styrene/ethylene-butylene/styrene block copolymers; l) polybutadiene; m) styrene butadiene rubber; n) ethylene propylene rubber; o) ethylene propylene diene rubber; p) dynamically vulcanized elastomers; q) ethylene vinyl acetates; r) ethylene (meth) acrylates; s) polyvinyl chloride resins; t) polyamides, amide-ester elastomers, and copolymers of ionomer and polyamide, including, for example, Pebax® thermoplastic polyether and polyester amides, commercially available from Arkema Inc; u) crosslinked trans-polyisoprene; v) polyester-based thermoplastic elastomers, such as Hytrel® polyester elastomers, commercially available from E. I. du Pont de Nemours and Company, and Riteflex® polyester elastomers, commercially available frodandelm Ticona; w) polyurethane-based thermoplastic elastomers, such as Elastollan® polyurethanes, commercially available from BASF; x) synthetic or natural vulcanized rubber; and/or y) and combinations thereof.

Compositions comprising an ionomer or a blend of two or more E/X- and E/X/Y-type ionomers are particularly suitable intermediate and cover layer materials. Preferred E/X- and E/X/Y-type ionomeric cover compositions include: (a) a composition comprising a “high acid ionomer” (i.e., having an acid content of greater than 16 wt %), such as Surlyn® 8150; (b) a composition comprising a high acid ionomer and a maleic anhydride-grafted non-ionomeric polymer (e.g., Fusabond® functionalized polymers). A particularly preferred blend of high acid ionomer and maleic anhydride-grafted polymer is a 84 wt %/16 wt % blend of Surlyn® 8150 and Fusabond®. Blends of high acid ionomers with maleic anhydride-grafted polymers are further disclosed, for example, in U.S. Pat. Nos. 6,992,135 and 6,677,401, the entire disclosures of which are hereby incorporated herein by reference; (c) a composition comprising a 50/45/5 blend of Surlyn® 8940/Surlyn® 9650/Nucrel® 960, preferably having a material hardness of from 80 to 85 Shore C; (d) a composition comprising a 50/25/25 blend of Surlyn® 8940/Surlyn® 9650/Surlyn® 9910, preferably having a material hardness of about 90 Shore C; (e) a composition comprising a 50/50 blend of Surlyn® 8940/Surlyn® 9650, preferably having a material hardness of about 86 Shore C; (f) a composition comprising a blend of Surlyn® 7940/Surlyn® 8940, optionally including a melt flow modifier; (g) a composition comprising a blend of a first high acid ionomer and a second high acid ionomer, wherein the first high acid ionomer is neutralized with a different cation than the second high acid ionomer (e.g., 50/50 blend of Surlyn® 8150 and Surlyn® 9120), optionally including one or more melt flow modifiers such as an ionomer, ethylene-acid copolymer or ester terpolymer; and (h) a composition comprising a blend of a first high acid ionomer and a second high acid ionomer, wherein the first high acid ionomer is neutralized with a different cation than the second high acid ionomer, and from 0 to 10 wt % of an ethylene/acid/ester ionomer wherein the ethylene/acid/ester ionomer is neutralized with the same cation as either the first high acid ionomer or the second high acid ionomer or a different cation than the first and second high acid ionomers (e.g., a blend of 40-50 wt % Surlyn® 8140 or 8150, 40-50 wt % Surlyn® 9120, and 0-10 wt % Surlyn® 6320).

Surlyn 8150®, Surlyn® 8940, and Surlyn® 8140 are different grades of E/MAA copolymer in which the acid groups have been partially neutralized with sodium ions. Surlyn® 9650, Surlyn® 9910, and Surlyn® 9120 are different grades of E/MAA copolymer in which the acid groups have been partially neutralized with zinc ions. Surlyn® 7940 is an E/MAA copolymer in which the acid groups have been partially neutralized with lithium ions. Surlyn® 6320 is a low modulus magnesium ionomer with a medium acid content. Nucrel® 960 is an E/MAA copolymer resin nominally made with 15 wt % methacrylic acid. Surlyn® ionomers, Fusabond® polymers, and Nucrel® copolymers are commercially available from The Dow Chemical Company.

Suitable E/X- and E/X/Y-type ionomeric cover materials are further disclosed, for example, in U.S. Pat. Nos. 6,653,382, 6,756,436, 6,894,098, 6,919,393, and 6,953,820, the entire disclosures of which are hereby incorporated by reference.

### Finishing Steps

Golf balls made in accordance with the present disclosure may be subjected to finishing steps such as flash-trimming, surface-treatment, marking, coating, and the like using techniques known in the art. In one embodiment, a white-pigmented cover may be surface-treated using a suitable method such as, for example, corona, plasma, or ultraviolet (UV) light-treatment. Indicia such as trademarks, symbols, logos, letters, and the like may be printed on the cover using pad-printing, ink-jet printing, dye-sublimation, or other suitable printing methods. Clear surface coatings (for example, primer and topcoats), which may contain a fluorescent whitening agent, may be applied to the cover. Golf balls may also be painted with one or more paint coatings in a variety of colors. In one embodiment, white primer paint is applied first to the surface of the ball and then a white top-coat of paint may be applied over the primer.

In one aspect, the golf balls disclosed herein can be unpainted balls and the colors can be realized via the first and second color concentrate additives. In other aspects, the golf balls disclosed herein can be painted to provide color shifting, or other effects such as a matte, glossy, or other effect or appearance.

### Golf Ball Properties

### Hardness

The hardness of the geometric center of the core may be obtained according to the following: the core is first gently pressed into a hemispherical holder having an internal diameter approximately slightly smaller than the diameter of the core, such that the core is held in place in the hemispherical portion of the holder while concurrently leaving the geometric central plane of the center exposed. The core is secured in the holder by friction, such that it will not move during the cutting and grinding steps, but the friction is not so excessive that distortion of the natural shape of the core would result. The core is secured such that the parting line of the center is roughly parallel to the top of the holder. The diameter of the center is measured 90 degrees to this orientation prior to securing. A measurement is also made from the bottom of the holder to the top of the core to provide a reference point for future calculations. A rough cut is made slightly above the exposed geometric center of the core using a band saw or other appropriate cutting tool, making sure that the core does not move in the holder during this step. The remainder of the core, still in the holder, is secured to the base plate of a surface grinding machine. The exposed ‘rough’ surface is ground to a smooth, flat surface, revealing the geometric center of the core, which can be verified by measuring the height from the bottom of the holder to the exposed surface of the core, making sure that exactly half of the original height of the core, as measured above, has been removed to within 0.004 inches. Leaving the core in the holder, the geometric center of the core is confirmed with a center square and carefully marked, and the hardness is measured at the center mark according to ASTM D-2240.

Additional hardness measurements at any distance from the geometric center of the core can then be made by drawing a line radially outward from the geometric center mark and measuring the hardness at any given distance along the line, typically in 2 mm increments from the center of the core. The hardness at a particular distance from the geometric center should be measured along at least two, preferably four, radial arms located 180° apart, or 90° apart, respectively, and then averaged. All hardness measurements performed on a plane passing through the geometric center are performed while the core is still in the holder and without having disturbed its orientation, such that the test surface is constantly parallel to the bottom of the holder, and thus also parallel to the properly aligned foot of the durometer.

The outer surface hardness of the core (or any golf ball layer) is measured on the actual outer surface of the layer and is obtained from the average of a number of measurements taken from opposing hemispheres, taking care to avoid making measurements on the parting line of the core or on surface defects, such as holes or protrusions and preferably making the measurements prior to surrounding the layer of interest with an additional layer. Hardness measurements are made pursuant to ASTM D-2240 “Indentation Hardness of Rubber and Plastic by Means of a Durometer.” Because of the curved surface, care must be taken to ensure that the golf ball or golf ball sub-assembly is centered under the durometer indenter before a surface hardness reading is obtained. A calibrated, digital durometer, capable of reading to 0.1 hardness units is used for the hardness measurements. The digital durometer must be attached to, and its foot made parallel to, the base of an automatic stand. The weight on the durometer and attack rate conforms to ASTM D-2240. It is worthwhile to note that, once an additional layer surrounds a layer of interest, the hardness of the layer of interest can be difficult to determine. Therefore, for purposes of the present disclosure, when the hardness of a layer is needed after the inner layer has been surrounded with another layer, the test procedure for measuring a point located 1 mm from an interface is used.

It should also be noted that there is a fundamental difference between “material hardness” and “hardness as measured directly on a golf ball” (or, as used herein, “surface hardness”). For purposes of the present disclosure, material hardness is measured according to ASTM D-2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of layers, and the like); ball (or ball sub-assembly) diameter; and the material composition of adjacent layers. It also should be understood that the two measurement techniques are not linearly related and, therefore, one hardness value cannot easily be correlated to the other. Shore hardness (for example, Shore C or Shore D hardness) was measured according to the test method ASTM D-2240.

A golf ball core made from the rubber formulation of the present disclosure may have a hardness at the geometric center of the core, referred to herein as HC, that ranges from about 40 to about 90 Shore C. In one embodiment, the core has a hardness at its geometric center of about 45 to about 65 Shore C or about 48 to about 58 Shore C or about 49 to about 52 Shore C. In another embodiment, the core has a hardness at its geometric center of about 55 to about 75 Shore C or about 60 to about 66 Shore C or about 68 to about 74 Shore C. In yet another embodiment, the core has a hardness at its geometric center of about 65 to about 85 Shore C or about 66 to about 74 Shore C or about 77 to about 84 Shore C.

The hardness at the surface of the core, referred to herein as HS, may range from about 60 to about 95 Shore C. In one embodiment, the hardness at the surface of the core is about 70 to about 95 Shore C or about 72 to about 82 Shore C or about 85 to about 95 Shore C or about 87 to about 93 Shore C. In another embodiment, the hardness at the surface of the core is about 65 to about 95 Shore C or about 73 to about 93 Shore C or about 74 to about 84 Shore C. In yet another embodiment, the hardness at the surface of the core is about 72 to about 95 Shore C or about 77 to about 85 Shore C or about 88 to about 94 Shore C.

The direction of the hardness gradient is defined by the difference in hardness measurements taken at the geometric center and outer surfaces of the core. The geometric center hardness is readily determined according to the test procedures provided above. For example, the hardness of the outer surface of the core is also readily determined according to the procedures given herein for measuring the outer surface hardness of a golf ball layer, if the measurement is made prior to surrounding the core with additional layers.

While the hardness gradient across the core will vary based on several factors including, but not limited to, the dimensions and formulations of the components, the core of the present disclosure has a “positive” hardness gradient (that is, the geometric center is softer than the outer surface of the core). More particularly, the term, “positive hardness gradient” as used herein means a hardness gradient of positive about 2 Shore C or greater, about 4 Shore C or greater, about 6 Shore C or greater, about 8 Shore C or greater, or about 10 Shore C or greater. In general, the hardness gradient may be determined by subtracting the hardness value of one component being measured (for example, the geometric center of the core, HC) from the hardness value of another component being measured (for example, the outer surface of the core, HS).

The core of the present disclosure has a positive hardness gradient. In one embodiment, the core has a positive hardness gradient from the geometric center to the surface of the core of about 2 Shore C to 42 Shore C. In this aspect, the positive hardness gradient of the core is about 5 Shore C to about 40 Shore C. The rubber formulation of the core may be tailored to produce a desired hardness gradient in the core. In some embodiments, the positive hardness gradient of the core is about 30 to about 42 Shore C or about 34 Shore C to 41 Shore C or about 37 Shore C to about 40 Shore C. In other embodiments, the positive hardness gradient of the core is about 3 Shore C to about 25 Shore C or about 10 Shore C to about 23 Shore C, or about 11 Shore C to about 17 Shore C. In further embodiments, the positive hardness gradient of the core may be about 2 Shore C to about 40 Shore C or about 7 Shore C to about 12 Shore C or about 8 Shore C to 11 Shore C.

The hardness of the core may not increase linearly from the center of the core to the outer surface of the core. For example, one or more regions within the core may have a “zero” hardness gradient, i.e., the hardness values across the region are substantially the same. The term, “zero hardness gradient” as used herein means a hardness gradient of −2 Shore C to 2 Shore C, preferably between about −1 Shore C and about 1 Shore C and may have a value of zero. In some embodiments, one or more regions of the core may also have a “negative” hardness gradient, i.e., the hardness values across the region may decrease from the inner edge of the region to the outer edge of the region.

For example, the core, or a layer of the core if the core has multiple layers, may be characterized by three regions: an inner region, an intermediate region, and an outer region. Each of the inner region, intermediate region, and outer region may have its own hardness gradient. For a single-layer core, the inner region is the region of the core surrounding the center of the core and is characterized by positive hardness gradient of about 2 Shore C to about 25 Shore C. In some embodiments, the positive hardness gradient of the inner region of the core is about 6 Shore C to about 25 Shore C or about 16 Shore C to about 23 Shore C. In other embodiments, the positive hardness gradient of the inner region of the core is about 1 Shore C to about 13 Shore C or about 6 Shore C to about 11 Shore C. In further embodiments, the positive hardness gradient of the inner region of the core is about 5 Shore C to about 9 Shore C or about 6 Shore C to about 8 Shore C.

The outer region of the core is the region of the core adjacent the surface of the core and may be characterized by a zero or positive hardness gradient from about −2 Shore C to about 28 Shore C. In some embodiments, the outer region may have a positive hardness gradient from 2 Shore C to about 27 Shore C or about 16 Shore C to about 27 Shore C or about 17 Shore C to about 22 Shore C. In other embodiments, the outer region may have a zero or positive hardness gradient from −2 Shore C to about 16 Shore C or about 2 Shore C to about 6 Shore C or about 10 Shore C to about 15 Shore C. In further embodiments, the outer region may have a zero or positive hardness gradient from −2 Shore C to about 14 Shore C or about 1 Shore C to about 8 Shore C or about 2 Shore C to about 6 Shore C.

The intermediate region of the core is the region of the core between the inner region and the outer region and may be characterized by a negative, zero, or positive hardness gradient from about −10 to 8 Shore C. In some embodiments, the intermediate region may have a negative, zero, or positive hardness gradient from −7 to about 6 Shore C or about −6 to about 1 Shore C. In other embodiments, the intermediate region may have a positive hardness gradient from −7 to about 4 Shore C or about −2 to about 4 Shore C. In further embodiments, the intermediate region may have a negative or zero hardness gradient from −10 to about 0 Shore C or about −4 Shore C to about 0 Shore C.

In some embodiments, a point or plurality of points measured along a “positive” gradient may be above or below a line fit through the gradient and its outermost and innermost hardness values. In an alternative embodiment, the hardest point along a particular steep “positive” gradient may be higher than the value at the innermost portion of the center (the geometric center) or outer surface of the core—as long as the outermost point (i.e., the outer surface of the core) is greater than the innermost point (i.e., the geometric center of the core), such that the “positive” gradients remain intact.

### Compression

Several different methods can be used to measure compression, including Atti compression, Riehle compression, load/deflection measurements at a variety of fixed loads and offsets, and effective modulus (see, e.g., Compression by Any Other Name, Science and Golf IV, Proceedings of the World Scientific Congress of Golf (Eric Thain ed., Routledge, 2002) (J. Dalton)). For purposes of the present disclosure, compression values are provided as measured by the Dynamic Compression Machine (“DCM”) as well as the Soft Center Deflection Index (“SCDI”). The DCM applies a load to a ball component or a ball and measures the number of inches the core or ball is deflected at measured loads. A crude load/deflection curve is generated that is fit to the Atti compression scale that results in a number being generated that represents an Atti compression. The DCM does this via a load cell attached to the bottom of a hydraulic cylinder that is triggered pneumatically at a fixed rate (typically about 1.0 ft/s) towards a stationary core. Attached to the cylinder is an LVDT that measures the distance the cylinder travels during the testing timeframe. A software-based logarithmic algorithm ensures that measurements are not taken until at least five successive increases in load are detected during the initial phase of the test.

The SCDI is a slight variation of the DCM set up that allows determination of the pounds required to deflect a component or ball 10 percent of its diameter. With the SCDI, the goal is to obtain the pounds of force required to deflect a component or ball a certain number of inches. That amount of deflection is 10 percent of the component or ball diameter. The DCM is triggered, the cylinder deflects the component or ball by 10 percent of its diameter, and the DCM reports back the pounds of force required (as measured from the attached load cell) to deflect the component or ball by that amount. The SCDI value obtained is a single number in units of pounds.

The compression of a core made from the rubber formulation of the present disclosure may range from about 20 to about 120 DCM or more preferably about 50 to about 120 DCM. For example, the core compression may be about 50 to about 85 DCM or about 60 to 80 DCM or about 65 to about 75 DCM. In another example, the core compression may range from about 50 to about 100 DCM or about 55 to about 65 DCM or about 80 to 100 DCM. In yet another example, the core compression is about 60 to about 120 DCM or about 110 to about 120 DCM or about 60 to about 80 DCM or about 71 to about 79 DCM. In some embodiments, it may be desirable for a core comprising the rubber formulation of the present disclosure to have a compression from about 68 to about 75 DCM or from about 70 to about 74 DCM regardless of the hardening agent used.

### Coefficient of Restitution

The golf ball cores of the present disclosure can be tailored to have a desired or targeted coefficient of restitution (CoR) value. In one example, it may be desirable to have a golf ball core with a relatively high CoR value. In one example, the CoR of the golf ball cores formed according to the present disclosure at 125 ft/s is about 0.740 or greater. In another example, the CoR of the golf ball core according to the present disclosure at 125 ft/s is about 0.860 or greater. One of ordinary skill in the art would understand based on the present disclosure that these CoR values can vary.

### Golf Ball Construction

Golf balls having various constructions may be made in accordance with the present disclosure. For example, golf balls having one-piece, two-piece, three-piece, four-piece, and five or more piece constructions with the term “piece” referring to any core, cover, or intermediate layer of a golf ball construction. Representative illustrations of such golf ball constructions are provided and discussed further below. The term, “layer” as used herein means generally any spherical portion of the golf ball.

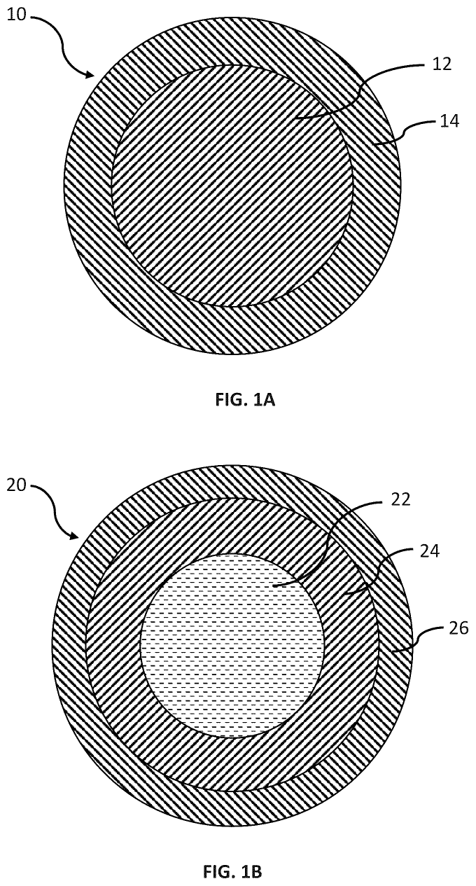

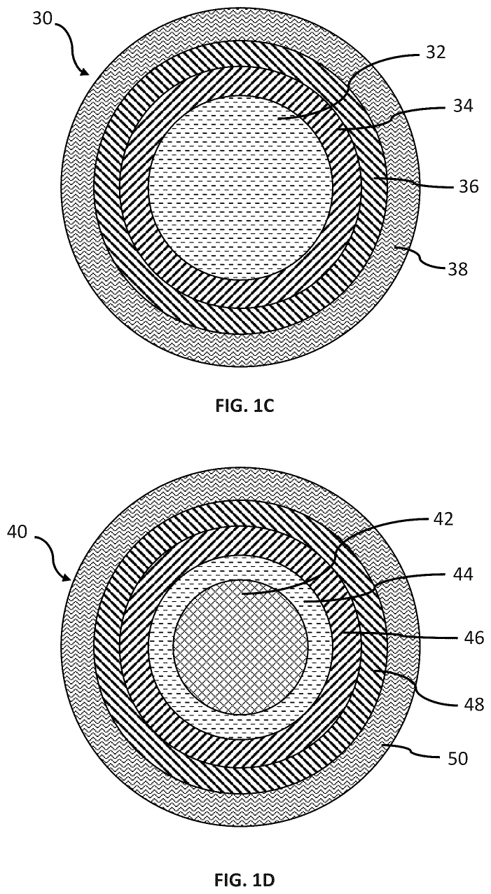

In one embodiment, a golf ball of the present disclosure is a one-piece ball where the core and cover form a single integral layer. In another version, shown in FIG. 1A, a golf ball of the present disclosure is a two-piece ball 10 comprising a single core layer 12 and a single cover layer 14.

As shown in FIG. 1B, in one aspect, the golf ball 20 comprises a core layer 22, an intermediate layer 24, and a cover layer 26. In FIG. 1B, the intermediate layer 24 can be considered an outer core layer, an inner cover layer, a mantle or casing layer, or any other layer disposed between the core layer 22 and the cover layer 26.

Referring to FIG. 1C, in another aspect, a four-piece golf ball 30 comprises an inner core layer 32, an outer core layer 34, an intermediate layer 36, and an outer cover layer 38. In FIG. 1C, the intermediate layer 36 may be considered a casing or mantle layer, or inner cover layer, or any other layer disposed between the outer core layer 34 and the outer cover layer 38 of the ball 30.

Referring to FIG. 1D, in another aspect, a five-piece golf ball 40 comprises a three-layered core having an inner core layer 42, an intermediate core layer 44, an outer core layer 46, an inner cover layer 48, and an outer cover layer 50. As exemplified herein, a golf ball in accordance with the present disclosure can comprise any combination of any number of core layers, intermediate layers, and cover layers.

Any one or more of the layers shown in FIGS. 1A-1D can include the color concentrate additives, as described herein. Any one or more of the layers shown in FIGS. 1A-1D can have a marbled appearance, as described herein.

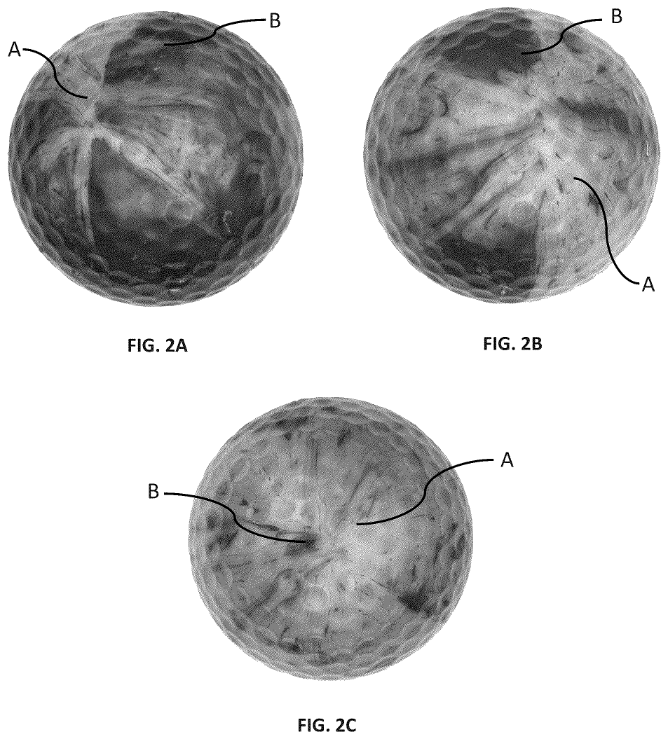

FIGS. 2A-2C illustrate exemplary golf balls formed according to the techniques described herein. As shown in FIGS. 2A-2C, a first color concentrate additive that is white (shown via annotations A), and a second color concentrate additive that is non-white (shown via annotations B), were added to a cover layer of the golf ball. In one example, the non-white color of the second color concentrate additive is blue, but one of ordinary skill in the art would understand that any color could be used.

FIGS. 2A-2C show exemplary golf balls with varying appearances. In one aspect, the varying appearances can be based on the amounts or proportions of the first and second color concentrate additives. In another aspect, the varying appearances can be based on varying mixing times. In another aspect, the varying appearances can be based on varying the introduction of one of the color concentrates into the base composition. One of ordinary skill in the art would understand that the varying appearances can be based on a variety of factors.

Although the golf balls shown in FIGS. 2A-2C include the first and second color concentrate additives in a cover layer, one of ordinary skill in the art would understand that other layers of the golf ball, such as a casing layer, intermediate layer, core, etc., could include the varying color concentrate additives. Any outer layers relative to the layer including the different color concentrate additives can be clear, translucent, transparent, or have other semi-transparent characteristics such that the underlying multi-color pattern is visible.

An exemplary method can include forming a golf ball component from a composition including a base material, a first color concentrate additive having a first color, and a second color concentrate additive having a second color. In one example, the first color concentrate additive has a first melt flow index, and the second color concentrate additive has a second melt flow index that is different than the first melt flow index. In another example, the first color concentrate additive has a first Mooney viscosity, and the second color concentrate additive has a second Mooney viscosity that is different than the first Mooney viscosity. The method can further comprise forming the golf ball component, such that the first color and the second color are each separately visible in the golf ball component. The golf ball component can include a core, an intermediate layer, or a cover. One of ordinary skill in the art would understand that the forming or formation step can include any known heating, curing, processing, mixing, blending, etc., steps that are used for processing or creating golf ball cores, intermediate layers, and/or covers. Further aspects of the golf ball component formation method are described herein.

A golf ball is disclosed herein that includes a core, a casing surrounding the core, and a cover surrounding the casing. At least one of the casing or the cover has a composition comprising: a thermoplastic or ionomer base, a first color concentrate additive, and a second color concentrate additive.

The first color concentrate additive can have a first melt flow index, and the second color concentrate additive can have a second melt flow index that is different than the first melt flow index. The melt flow indices can be sufficiently different that an appreciable and discernable difference in the melt flow index of the color concentrate additives manifests during ordinary formation and/or curing techniques.

In one example, the first color concentrate additive is white, and the second color concentrate additive is non-white. Alternatively, the first color concentrate additive is non-white, and the second color concentrate additive is white. Alternatively, both the first and second color concentrate additives can be non-white.

In one example, the second melt flow index is less than the first melt flow index. The second melt flow index can be at least 50% less than the first melt flow index in one example. The second melt flow index can be at least 75% less than the first melt flow index in one example. The second melt flow index can be no greater than 5% less than the first melt flow index in one example. In one example, the second melt flow index is at least 5%-100% greater than the first melt flow index. In another example, the second melt flow index is at least 5%-100% less than the first melt flow index.

In one example, the first color concentrate additive is configured to flow using the ASTM D1238 testing standard at a testing temperature and testing mass at a certain rate (i.e., a quantifiable melt flow index) while the second color concentrate additive does not flow using the ASTM D1238 testing standard at the testing temperature and mass. In another example, the first color concentrate additive does not flow using the ASTM D1238 testing standard at a testing temperature and testing mass, while the second color concentrate additive is configured to flow at a certain rate using the ASTM D1238 testing standard at the testing temperature and mass. In one example, both of the color concentrate additives are configured to flow using a testing standard with a testing temperature and mass, but at different rates. One of ordinary skill in the art would appreciate that other testing standards could be used, such as ISO 1133, and the first and second color concentrate additives can exhibit different flow rates, or one of the color concentrate additives can be configured to flow while the other one of the color concentrate additives can be configured to not flow using the specific testing standard.

In another example, the casing can have a composition comprising the thermoplastic or ionomer base, the first color concentrate additive, and the second color concentrate additive, and the cover can be transparent such that the mixing of the first and second color concentrate additives is visible through the cover.

The cover can have the composition comprising the thermoplastic or ionomer base, the first color concentrate additive, and the second color concentrate additive.

The thermoplastic or ionomer base can have a third melt flow index that is greater than both the first melt flow index and the second melt flow index.

In another example, a golf ball is disclosed that includes a core having a composition comprising a thermoset rubber base, a first color concentrate additive, and a second color concentrate additive. A casing surrounds the core, and a cover surrounds the casing. The first color concentrate additive can have a first Mooney viscosity, and the second color concentrate additive can have a second Mooney viscosity that is different than the first Mooney viscosity. The casing and the cover can be transparent. The thermoset rubber base of the core can have a third Mooney viscosity that is less than the first Mooney viscosity and the second Mooney viscosity. Based on these intentionally varying Mooney viscosities, the base rubber will be mixed at a first rate, and the color concentrate additives will be mixed at two different rates. The difference in the Mooney viscosities provides an intentional and inherently unique blending pattern and process. The first color concentrate additive can be white, and the second color concentrate additive can be non-white. One of ordinary skill in the art would understand that materials other than a thermoset rubber can be used as a base of the composition.

In yet another example, a golf ball is disclosed herein that includes a core, and a cover surrounding the core. The cover can have a composition comprising: a thermoplastic or ionomer base, a first color concentrate additive, and a second color concentrate additive. The first color concentrate additive can have a first melt flow index, and the second color concentrate additive can have a second melt flow index that is different than the first melt flow index.

In one example, a larger volume of the first color concentrate additive, which can be white, can be added than the second color concentrate additive, which can be non-white. In one example, a larger volume of the first color concentrate additive, which can be non-white, can be added than the second color concentrate additive, which can be white.

In one example in which the casing and/or the cover has a colored pattern, the color concentrate additives can be introduced to the base composition anywhere between 0.5 wt %-10.0 wt % based on a total weight of the base composition. In one example, the first color concentrate additive is added at 0.1 wt %-5.0 wt % based on a total weight of the base composition, and the second color concentrate additive is added at 0.1 wt %-5.0 wt % based on a total weight of the base composition. In one example, the first color concentrate additive is added at 0.1 wt %-1.0 wt % based on a total weight of the base composition and the second color concentrate additive is added at 5.0 wt %-10.0 wt % based on a total weight of the base composition. One of ordinary skill in the art would understand that these values are provided for exemplary purposes and the specific amounts of color concentrate additives in the compositions can vary.

In one example in which the core has a colored pattern, the color concentrate additives can be introduced to the base composition anywhere between 0.1 wt %-1.0 wt % based on a total weight of the base composition. The first color concentrate additive can be added at 0.1 wt %-1.0 wt % based on a total weight of the base composition, while the second color concentrate additive can be added at 0.01 wt %-0.1 wt % based on a total weight of the base composition. One of ordinary skill in the art would understand that these values are provided for exemplary purposes and the specific amounts of color concentrate additives in the compositions can vary.

The process or method of mixing the color concentrate additives can be carried out according to know manufacturing processes, such as disclosed in U.S. Pat. Nos. 7,446,150, 7,491,787, 7,649,072, 8,529,376, 8,758,168, and 10,035,043, each of which are commonly assigned to Acushnet Company and each of which are incorporated in their entirety as if fully set forth herein. In one aspect, the color concentrate additives can be sprinkled in during known formation or mixing techniques for forming a golf ball core, cover, casing, or intermediate layer. The color concentrate additives can be added to the base composition at the same time or staggered relative to each other.

In one aspect, mixing or blending of the color concentrate additives and the base compositions can be achieved according to methods familiar to those in the art, for example, with a two roll mill, a Banbury mixer or a single or twin-screw extruder. The single screw extruder can have a grooved barrel wall, comprise a barrier screw or be of a shortened screw design. The twin screw extruder may be of the counter-rotating non-intermeshing, co-rotating non-intermeshing, counter-rotating fully intermeshing or co-rotating fully intermeshing type. In one example, the mixture of color concentrate additives and base composition can then be placed into a hopper which is used to feed the heated barrel of an injection molding machine. Further mixing can be accomplished by a screw within the heated injection barrel. As further disclosed in U.S. Pat. No. 7,285,058, which is commonly assigned to Acushnet Company and incorporated in its entirety as if fully set forth herein, suitable mixing methods can include single pass mixing (i.e., ingredients are added sequentially), multi-pass mixing, and the like. The crosslinking agent, and any other optional additives used to modify the characteristics of the golf ball center or additional layer(s), may similarly be combined by any type of mixing. Suitable mixing speeds and temperatures are well-known to one of ordinary skill in the art, or may be readily determined without undue experimentation. Any of these known mixing techniques or processes can be used for integrating the color concentrate additives with the base compositions, whether in a core layer, intermediate layer, or cover layer.

In one example, in order to blend the color concentrate additives with the base composition when forming the casing or the cover, the mixture of the base composition and the color concentrate additives can be heated to at least 200° F. In one example, a melting temperature of at least 300° F. can be used. In another example, a melting temperature of at least 450° F. can be used. A melting temperature of 250° F.-600° F. can be used in another example.

In one example, a base material and the color concentrate additives can each be added at the same time to form the composition of the specific layer. The variations in the appearance of the color concentrate additives are thereby not based on adding the color concentrates additives at different times during the mixing, heating, or curing cycle, but instead based on the inherently different material properties of the color concentrate additives. The color concentrate additive having a lower melt flow index will inherently mix or blend less into the composition as compared to the color concentrate additive having a higher melt flow index. Likewise, the color concentrate additive having a higher Mooney viscosity will inherently mix or blend less into the composition as compared to the color concentrate additive having a lower Mooney viscosity. In another example, the color concentrate additives can be added at different times during the mixing, formation, curing, or heating steps.

According to one aspect, using the techniques and configurations disclosed herein, a golf ball is provided that has a marbled appearance. In one aspect, two or more colors provided via the two or more different color concentrate additives can be manifested within any one or more layers or portions of the golf ball. The various colors can be formed within a single layer or portion of the golf ball. The various colors can be mixed with each other such that the various colors remain identifiable in the mixture. For example, the various colors can be mixed with each other such that streaking of one color is visible in the other color. In another example, specks or dots of one color can be visible in the other color. A first color concentrate additive can be included at a greater concentration than a second color concentrate additive such that the first color concentrate additive defines a base or background color, and the second color concentrate additive defines a secondary color that can be visible relative to the base or background color via steaking, veining, etc. The second color concentrate additive can be provided in lower proportions relative to the first color concentrate additive such that the visual effect or appearance of the second color concentrate additive is limited relative to the first color concentrate additive.

In one aspect, the present disclosure provides a golf ball having unique visual characteristics. Based on these features, the golf ball is desirable for golfers in order to efficiently and quickly identify their specific golf ball on a golf course. Identification of conventional golf balls can require golfers to manually the inspect golf balls for a specific identifying characteristic, such as a play number on the golf ball. The present golf ball instead provides a unique identifying characteristic that can be more easily seen from a distance (such as at least 10 yards, 50 yards, or 100 yards, in some examples) and allows golfers to quickly identify their golf ball, thereby increasing pace of play, among other benefits. The golf balls disclosed herein have unique characteristics, which can further provide improved tracking of golf balls midflight and during other shots on a golf course. The marbling pattern can also be more easily seen during certain environmental conditions, such as sun glare caused by sunrise or sunset conditions, as compared to conventional golf balls. Additionally, the golf balls disclosed herein can provide an improved visual cue for golfers to focus on during swinging, striking, or putting. As the golf balls disclosed herein inherently have a varying pattern across the surface of the golf ball, golfers can use the unique patterning in order to focus on striking a specific portion of the golf ball. Accordingly, the golf balls provide unique features that provide benefits in a variety of ways during pre-shot, mid-shot, and post-shot stages of golfing.

One of ordinary skill in the art would recognize from this disclosure that in addition to appearance or color, Mooney viscosity, and/or melt flow index, the color concentrates can have various other distinct material properties, such as density, specific gravity, hardness, malleability, solubility, etc.

The terms “about” and “approximately” shall generally mean an acceptable degree of error or variation for the quantity measured given the nature or precision of the measurements.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure.

The golf balls and formation processes described and claimed herein are not to be limited in scope by the specific embodiments herein disclosed, since these embodiments are intended as illustrations of several aspects of the disclosure. Any equivalent embodiments are intended to be within the scope of this disclosure. Indeed, various modifications of the device in addition to those shown and described herein will become apparent to those skilled in the art from the foregoing description. Such modifications are also intended to fall within the scope of the appended claims. All patents and patent applications cited in the foregoing text are expressly incorporated herein by reference in their entirety.

What is claimed is:

1. A method for forming a golf ball component, the method comprising:
forming a composition including a base material, a first color concentrate additive having a first color, and a second color concentrate additive having a second color,
wherein at least one of:
(i) the first color concentrate additive has a first melt flow index, and the second color concentrate additive has a second melt flow index that is different than the first melt flow index; or
(ii) the first color concentrate additive has a first Mooney viscosity, and the second color concentrate additive has a second Mooney viscosity that is different than the first Mooney viscosity, and
forming the golf ball component from the composition, such that the first color and the second color are each separately visible in the golf ball component,
wherein the golf ball component is a core, an intermediate layer, or a cover.

2. The method according to claim 1, wherein the first color concentrate additive is white, and the second color concentrate additive is non-white, such that the first and second color concentrate additives are configured to form a marbled pattern in the composition.

3. The method according to claim 1, wherein the first color concentrate additive is a first non-white color, and the second color concentrate additive is a second non-white color, such that the first and second color concentrate additives are configured to form a marbled pattern in the composition.

4. The method according to claim 1, wherein the first and second color concentrate additives are semi-immiscible.

5. The method according to claim 1, wherein the core includes the composition, and the base material is comprised of a thermoset rubber.

6. The method according to claim 1, wherein the cover includes the composition, and the base material is comprised of polyurethane, polyurea, a hybrid of polyurethane-polyurea, or ionomer.

7. The method according to claim 1, wherein the intermediate layer includes the composition, and the base material is comprised of ionomer.

8. The method according to claim 1, wherein the first color concentrate additive is configured to flow using a testing standard with a testing temperature and a testing mass, and
the second color concentrate additive does not flow using the testing standard with the testing temperature and the testing mass.

9. The method according to claim 1, wherein the second melt flow index is less than the first melt flow index.

10. The method according to claim 1, wherein the base material has a third melt flow index that is greater than both the first melt flow index and the second melt flow index.

11. The method according to claim 1, wherein the base material has a third Mooney viscosity that is less than both the first Mooney viscosity and the second Mooney viscosity.

12. The method according to claim 1, wherein:
(i) the second melt flow index is at least 5% different than the first melt flow index; or
(ii) the second Mooney viscosity is at least 5% different than the first Mooney viscosity.

13. The method according to claim 1, wherein the composition includes a first percentage by weight of the first color concentrate, and a second percentage by weight of the second color concentrate, and the first percentage by weight and the second percentage by weight are different.

14. The method according to claim 13, wherein the composition is in the core, and the first percentage by weight is 0.1 wt %-1.0 wt %, and the second percentage by weight is 0.1 wt %-1.0 wt %.

15. The method according to claim 13, wherein the composition is in the intermediate layer or the cover, and the first percentage by weight is 0.1 wt %-10.0 wt %, and the second percentage by weight is 0.1 wt %-10.0 wt %.

16. A golf ball comprising:
a core; and
at least one layer disposed about the core;
wherein the at least one layer has a composition comprising:
a base material comprised of polyurethane, polyurea, hybrid of polyurethane-polyurea, or ionomer,
a first color concentrate additive having a first color, and
a second color concentrate additive having a second color, and
wherein the first color concentrate additive has a first melt flow index, and the second color concentrate additive has a second melt flow index that is different than the first melt flow index,
such that the first color and the second color are each separately visible in the at least one layer, and the first and second color concentrate additives are configured to form a marbled pattern in the composition.

17. The golf ball according to claim 16, wherein the first color concentrate additive is white and the second color concentrate additive is non-white, or
the first color concentrate additive is a first non-white color, and the second color concentrate additive is a second non-white color.

18. The golf ball according to claim 16, wherein the first color concentrate additive is configured to flow using a testing standard with a testing temperature and a testing mass, and the second color concentrate additive does not flow using the testing standard with the testing temperature and the testing mass.

19. The golf ball according to claim 16, wherein the second melt flow index is at least 5% different than the first melt flow index.

20. A golf ball comprising:
a core having a composition comprising a rubber base material, a first color concentrate additive having a first color, and a second color concentrate additive having a second color; and
a cover disposed about the core;
wherein the first color concentrate additive has a first Mooney viscosity, and the second color concentrate additive has a second Mooney viscosity that is different than the first Mooney viscosity, such that the first color and the second color are each separately visible in the core, and the first and second color concentrate additives are configured to form a marbled pattern in the composition,
wherein the rubber base material of the core has a third Mooney viscosity that is less than the first Mooney viscosity and the second Mooney viscosity,
the first color concentrate additive is white, and the second color concentrate additive is non-white, and
the first Mooney viscosity is at least 5% different than the second Mooney viscosity.
